(19) United States
(12) Patent Application Publication
(10) Pub. No.: US 2011/0157601 A1
(43) Pub. Date: Jun. 30, 2011

(54) ANALYSIS OF TRANSPARENT BIOLOGICAL OBJECTS

(76) Inventors: Mikael Carl Sebesta, Dalby (SE); Anna Mölder, Blentarp (SE); Lennart Gisselsson, Lund (SE)

(21) Appl. No.: 12/999,503

(22) PCT Filed: Jun. 17, 2009
(86) PCT No.: PCT/SE09/50752

§ 371 Date: Mar. 2, 2011

(30) Foreign Application Priority Data
Jun. 19, 2008 (SE) 0801452-4

(51) Int. Cl. G01B 11/02; G01N 1/10

(52) U.S. Cl. 356/511; 356/246

(57) ABSTRACT

The present invention relates to an observation vessel for digital holo-graphic microscopy of at least one transparent biological object, an observation vessel lid for digital holographic microscopy of at least one transparent biological object as well as a method for analyzing a sample comprising at least one transparent biological object and at least one medium by means of digital holographic microscopy.

### TECHNICAL FIELD OF THE INVENTION

The present invention relates to an observation vessel for digital holographic microscopy of at least one transparent biological object, an observation vessel lid for digital holographic microscopy of at least one transparent biological object as well as a method for analyzing a sample comprising at least one transparent biological object by means of digital holographic microscopy.

### BACKGROUND ART

There exists a never ending demand for additional and more accurate information about biological objects, such as cells, in humans, animals, plants and other organisms. Cells have for a long time been studied by means of light microscopy, such as fluorescence, confocal and phase contrast microscopy. However, when using fluorescence or confocal microscope the cells must be marked or stained and the used marker or stain has a potential toxic effect on the cells that may be influenced and thereby the development of the cells is disturbed. In addition, the marker may be bleached over time, which renders the study of cell development over substantial time ranges difficult. When using fluorescence microscope also the focal plane must be set mechanically and this may be distorted over time by e.g. temperature changes in the ambient environment. Further, with a confocal microscope, only one point is illuminated at a time and in order to achieve a 2- or 3-dimensional image scanning is required.

In many cases it is important to be able to study living cells without the risk of influencing the cell and the cell development by toxic markers or stains. Phase contrast microscopy enables the study of living cells without the need for markers. However, phase contrast microscopy does not allow quantification of the phase shift of the studied object, which implies that it is difficult to quantify the area of distribution or the thickness of the cell. The disadvantages of mechanical setting of the focal plane also apply to the phase contrast microscope. In addition, since the studied object normally has an irregular upper surface the focal plane differs from one spot to another. Thereby, it is not possible to achieve a sharp image of all portions of the object in one image. Several images with varying setting of the focal plane must be produced in order to achieve sharp visualization of all portions of the object. Especially if the studied object has protrusions, the sharpness of one image will be unsatisfactory, since the protrusions will not be in the same focal plane.

Digital holographic microscopy enables studies of living cells without the need for markers or stains and enables quantification of the studied objects. The possibilities of digital holographic microscopy have increased during the last years due to the dramatic development of digital sensors and computers.

One way to study cells by means of digital holographic microscopy is disclosed in WO 2007/073345, where a method for analyzing a stage of development of cells and a device for enablement of the analysis are disclosed. The cell sample is kept in a cell culture vessel of standard type. However, the quality of the holograms and thereby the accuracy of the information achieved by this method and device are limited. Therefore, there is still a demand for an improved technique that will result in holograms with a high quality and true information about the studied objects.

### SUMMARY OF THE INVENTION

An object of the present invention is to provide accurate phase and amplitude information about transparent biological objects. This accurate information may be utilized to produce high-resolution holographic images of the transparent biological objects.

This and further objects are achieved by an observation vessel for digital holographic microscopy comprising a first holding means and a second holding means, wherein said first holding means comprises a first outer surface and a first inner surface and said second holding means comprises a second inner surface and a second outer surface,

wherein said first and second inner surfaces are provided to keep a sample comprising at least one transparent biological object and at least one medium and to be in contact with said sample.

This observation vessel enables a visualization of biological objects. The visualization is possible without having to mark or stain the objects, which is time consuming and costly. Thus, the observation vessel enables the study of living cells and the development of cells, such as cell growth. The observation vessel also enables the study of objects in a small sample volume. In particular, this observation vessel enables a low rate of undesired interference, low levels of noise, accurate phase and amplitude information about transparent biological objects as well as high-resolution holographic images of the biological objects.

Further features and embodiments of the observation vessel according to the present invention are disclosed in the subsequent dependent claims 2-10.

The above object is also achieved by an observation vessel lid for digital holographic microscopy comprising a first holding means, wherein said first holding means comprises a first outer surface and a first inner surface,

wherein said first inner surface is provided to be immersed into a sample comprising at least one transparent biological object and at least one medium and to be in contact with said sample.

This observation vessel lid enables a visualization of biological objects. The visualization is possible without having to mark or stain the objects, which is time consuming and costly. Thus, the observation vessel lid enables the study of living cells and the development of cells, such as cell growth. The observation vessel lid also enables the study of objects in a small sample volume. In particular, this observation vessel lid enables a low rate of undesired interference, low levels of noise, accurate phase and amplitude information about transparent biological objects as well as high-resolution holographic images of the biological objects.

Further features and embodiments of the observation vessel lid according to the present invention are disclosed in the subsequent dependent claims 12-18.

The above object is also achieved by a method for analyzing a sample comprising at least one transparent biological object and at least one medium by means of digital holographic microscopy, wherein said sample is kept in an observation vessel as defined in any one of the claims related thereto or located below an observation vessel lid as defined in any one of the claims related thereto, wherein said sample is in contact with said first inner surface and, if present, said second inner surface, comprising the steps of

a) creating at least one object beam and at least one reference beam of light, where said at least one object beam and said at least one reference beam are mutually coherent;

b) passing said at least one object beam through said first inner and outer surfaces and, if present, through said second inner and outer surfaces and thereby exposing said sample to said at least one object beam;

c) superimposing said at least one object beam that has passed through said sample with said at least one reference beam and thereby creating an interference pattern;

d) detecting said interference pattern, called hologram; and

e) reconstructing phase and/or amplitude information of object wavefront from said interference pattern.

This method enables a visualization of biological objects. The visualization is possible without having to mark or stain the objects, which is time consuming and costly. The method is non-destructive, since the analyzed objects are unaffected by the analysis. The method enables the study of living cells and the development of cells, such as cell growth. The method also enables determination of cell status, such as shape, density, volume and viability (fraction of living cells) as well as the stage in the cell cycle. The method also enables the study of objects in a small sample volume. The method is a full-field technology, where the sample is analyzed without having to scan the area. In addition, the method implies that it is possible to save the achieved data and to study and process the data afterwards in another environment or at another time. Several focal planes may be studied without having to mechanically set the microscope in relation to the different focal planes. Instead the different focal planes may be studied by processing the achieved data. Thereby, 3-dimensional images may be obtained. In particular, this method achieves a low rate of undesired interference, low levels of noise, accurate phase and amplitude information about transparent biological objects as well as high-resolution holographic images of the biological objects.

Further features and embodiments of the method according to the present invention are disclosed in the subsequent dependent claims 20-23.

### BRIEF DESCRIPTION OF THE DRAWINGS

The present invention can be more fully understood from the following detailed description when taken in conjunction with the accompanying drawings.

FIG. 1 is a schematic illustration of an embodiment of an observation vessel according to the present invention.

FIG. 2 is a schematic illustration of a wavefront of an object beam before and after passage of a transparent biological object.

FIG. 3 is a perspective view of an embodiment of an observation vessel according to the present invention.

FIG. 4 is a perspective view of another embodiment of an observation vessel according to the present invention.

FIG. 5 is a side view of the embodiment shown in FIG. 4.

FIG. 6 is a top view of an embodiment of an observation vessel lid according to the present invention.

FIG. 7 is a side view of the embodiment shown in FIG. 6.

### DETAILED DESCRIPTION OF PREFERRED EMBODIMENTS OF THE INVENTION

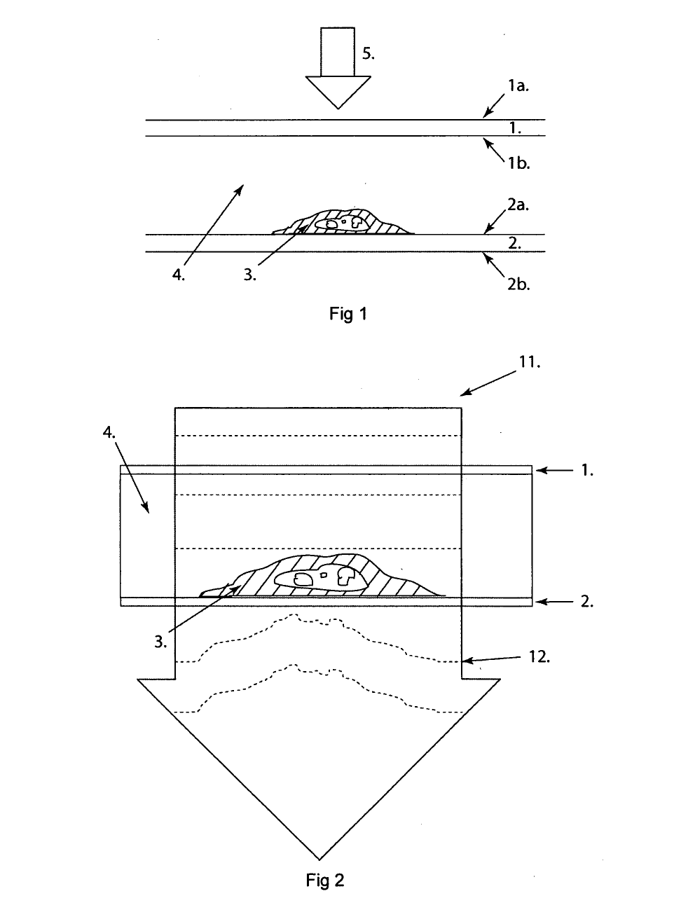

As shown in FIG. 1, an observation vessel according to the present invention comprises a first holding means 1 and a second holding means 2. The first holding means 1 comprises a first outer surface 1a and a first inner surface 1b. The second holding means comprises a second inner surface 2a and a second outer surface 2b. The first inner surface 1b and the second inner surface 2a are provided to keep a sample comprising at least one trans-parent biological object 3 and at least one medium 4 and to be in contact with the sample. In addition, FIG. 1 shows an object beam 5 and its relation to the first holding means 1 and the second holding means 2.

In one embodiment of the method according to the present invention, the mutually coherent at least one object beam and at least one reference beam of light are created by dividing a light beam originating from a coherent light source into two beams e.g. by means of a beam splitter. The light beam originating from a coherent light source may be a laser beam. The laser beam may originate from any kind of laser source, such as a He—Ne laser emitting light at a wavelength of 633 nm.

The object beam and the reference beam are mutually coherent, which implies that they have the same frequency and exhibit a constant phase relationship during the course of time.

The object beam is passed through the first outer and inner surfaces and then through the at least one biological object, after which the object beam is passed through the second inner and outer surfaces or, if an observation vessel lid according to the present invention is combined with another type of vessel, through the inner and outer surfaces of the bottom of that vessel. The reference beam is left unaffected by the at least one biological object, since the reference beam is guided another path than the object beam, e.g. by means of mirrors or fibre optics.

The sample is kept between the first and second inner surfaces.

As is shown in FIG. 2, the object beam has a known wavefront 11 before passing through the sample comprising at least one transparent biological object 3. When the object beam passes through the at least one trans-parent biological object, the biological object(s) substantially does (do) not absorb any light, but the light that travels through the biological object(s) will experience a difference in the optical path length compared to the surrounding medium. The wavefront that emerges from the biological object(s), the object wavefront 12, will thus be phase shifted, which is shown in FIG. 2. Naturally, also the reference beam has a known wavefront. The optical path length is defined as the physical/geometrical thickness multiplied with the refractive index.

In one embodiment of the method according to the present invention, the superimposing of the at least one object beam that has passed through the sample comprising at least one transparent biological object and the at least one reference beam is achieved by bringing the two beams together e.g. by means of another beam splitter. This superimposition gives rise to an interference pattern, which for example includes information about the object wavefront that is affected by the at least one biological object.

In one embodiment of the method according to the present invention, the interference pattern is detected by means of a digital sensor, such as a CCD or a CMOS. The detected interference pattern is called a hologram.

In order to superimpose the at least one object beam that has passed through the sample comprising at least one transparent biological object and the at least one reference beam and thereby creating an interference pattern and to detect the interference pattern for example a Fourier setup or a Fresnel setup may be used. Preferably a Fresnel setup is used.

From the detected interference pattern phase and/or amplitude information of the object wavefront is reconstructed. The reconstruction is carried out by means of any common reconstruction process. The amplitude information may be used to set the focal plane of interest. The reconstructed information may for example be used to obtain an image in 2 or 3 dimensions of the studied at least one biological object. The information may for example also be used to determine shape and optical density of the at least one biological object and when one or more cells are studied also the stage in the cell cycle.

As an alternative for creating one object beam and one reference beam, in-line digital holography may be used. It is obvious for a person skilled in the art how to modify the method of the present invention in order to use in-line digital holography, when studying this specification.

In a conventional system, where the sample is kept in an open vessel without any first holding means, there is a free surface of the sample. This free surface will not be flat and will always vibrate due to vibrations of the surrounding ground or equipment and/or movements in the ambient air. The irregularity and the vibrations of the sample surface will induce irregular scattering and noise to the object beam and thus result in low quality holograms and inaccurate phase and amplitude information. The fact that the sample according to the present invention is in contact with the first inner surface and, if present, the second inner surface implies that the surfaces of the sample always are as flat as the surfaces of the first inner surface and, if present, the second inner surface. In addition the vibrations of the surface of the sample are eliminated. Thereby, the scattering and the noise of the object beam are reduced. Thus, the quality of the hologram is found to be improved and thereby also the accuracy of the phase and amplitude information.

The fact that the sample according to the present invention is in contact with the first inner surface and, if present, the second inner surface implies that the number of interfaces between different material that the at least one object beam passes through is reduced. In a system where the sample only is in contact with the second inner surface, or corresponding inner surface of another type of vessel, and where there is a space (filled by air or another medium) between the surface of the sample and the first inner surface, the object beam passes through the interface between the first holding means and the space and also the interface between the space and the sample. In addition, in such a system, there will normally be condensate on the first inner surface, which further increases the number of interfaces which the object beam passes, since the object beam then passes through the interface between the first holding means and the condensate and the interface between the condensate and the space before it passes through the interface between the space and the sample. In the present invention, instead, the object beam passes through the interface between the first holding means and the sample, which eliminates at least one, and normally two, interface passages. Thereby one source of internal interference is eliminated, which reduces the scattering and the noise of the object beam. Thus, the quality of the hologram and the accuracy of the phase and amplitude information are found to be improved. In addition, the same problem as with the open vessel applies to this system, making the present invention even more advantageous.

The elimination of the irregularities and vibrations of the sample surface as well as the decreased number of interface passages for the object beam are very important improvements related to the present invention. These improvements reduce the scattering and thus the noise of the object beam considerably. Thereby, the undesired internal interference is appreciably decreased. As disclosed above, the interference pattern includes information about the object wavefront. Preferably, the object wavefront is only affected by the transparent biological object(s) and not by the equipment used to determine the object wavefront, as visualized in FIG. 2. If present, effects of the equipment will give rise to undesired internal interference. The artifacts, i.e. the errors and distortions induced by the used equipment, are reduced by the above improvements. Consequently, by these improvements, the accuracy of the phase and amplitude information is substantially improved.

According to one embodiment of the present invention, reflections arising when the at least one object beam passes through one or more of the first inner and outer surfaces and, if present, second inner and outer surfaces are reduced or eliminated. The reflection occurring when a beam incides against an interface between different materials in order to pass through the interface scatters the light and thereby noise is added to the hologram. The reduction or elimination of reflections decreases the amount of scattered light. This reduces the internal interference. Thus, the noise is decreased and thereby the quality of the hologram and the accuracy of the phase and amplitude information are improved. The reduction or elimination of reflections also increases the amount of light that is transmitted the desired path through the holding means and possibly the at least one biological object. In one embodiment, the reflections are reduced or eliminated by that at least one of the first inner and outer surfaces and, if present, second inner and outer surfaces is anti-reflection treated. An anti-reflection treatment of the surfaces is an efficient way of reducing reflections arising when the object beam passes through the first inner and outer surfaces and, if present, the second inner and outer surfaces. This reduction of reflections improves the quality of the hologram as well as the accuracy of the phase and amplitude information. In one embodiment, the reflections are reduced or eliminated by that at least one of the first outer surface and, if present, second outer surface is anti-reflection treated. Preferably, the second outer surface is anti-reflection treated. The reflections are reduced to a large extent when the first outer surface and/or the second outer surface, in particular when the second outer surface, are anti-reflection treated resulting in a substantial improvement of the quality of the hologram and thus also of the accuracy of the phase and amplitude information. In one embodiment, the anti-reflection treated surface is achieved by a coating on the surface, preferably by an interference anti-reflection coating.

In one embodiment of the present invention, the first and second inner surfaces are parallel to each other. By using parallel surfaces, the geometry of the observation vessel is simple and known per se. The optical paths of the beams are therefore easier to predict. Thereby, the theoretical expressions and calculations are facilitated.

According to one embodiment of the present invention, at least one of the first holding means and, if present, second holding means is at least partly permeable to gas, such as oxygen and/or carbon dioxide. This enables that gases essential for the survival of biological objects, such as cells are trans-ported into the sample and thereby it is possible to study one or more living cells during a substantial time period. It is also possible to keep and grow cells in the observation vessel and study the cells at different times without having to transfer the cells from one vessel used during digital holographic microscopy and one vessel used during development or growth of the cells.

In one embodiment of the present invention, the first holding means is at least partly made of glass, since the use of glass enhances the optical properties of the holding means. Glass, which is an amorphous material, is normally manufactured without any specific orientation of its components and thereby glass is non-polarizing. The manufacturing processes for producing plastic, such as extrusion and compression moulding, normally affect the orientation of its components, such that the plastic material polarizes a beam of light passing the material. The object beam passing a holding means made of plastic will thus be polarized giving rise to undesired internal interference. The non-polarizing glass will not give rise to polarization and therefore improves the quality of the hologram and the accuracy of the phase and amplitude information. In addition, since glass is an optically advantageous material that is possible to manufacture with very flat surfaces, the scattering of the object beam when passing through the first holding means made of glass will be further reduced. Thereby, the quality of the hologram and the accuracy of the phase and amplitude information are increased.

According to one embodiment of the present invention, the second holding means is at least partly made of plastic. When using plastic it is possible to achieve permeability of the holding means, since plastic may be made permeable to gases.

In one embodiment of the present invention, at least one of the first and second inner and outer surfaces comprises a pattern for positioning of the observation vessel or the observation vessel lid in relation to a beam of light inciding against the first outer surface, i.e. the at least one object beam of light. The pattern may for example be a grid, e.g. a grid of lines or dots, or a compass card-like sign. This pattern enables the observation vessel or the observation vessel lid to be positioned at the same spot each time it is analyzed. This implies that the same at least one biological object may be studied over a long period of time by analyzing the biological object(s) at separate times, since because of the positioning pattern the same biological object(s) easily is (are) located each time. One embodiment of the method according to the present invention comprises a step of positioning the observation vessel or the observation vessel lid in relation to the at least one object beam, preferably by means of a positioning pattern, which step is performed before step b. This step may be performed before or after step a, preferably after step a. The pattern is preferably located on or in at least one of the first inner and outer surfaces and, if present, second inner and outer surfaces.

According to one embodiment of the present invention, the observation vessel or observation vessel lid comprises at least one reference point decreasing or eliminating occurrence of biological objects. At least one of the first inner surface and, if present, second inner surface, preferably the second inner surface, is normally treated to promote attaching of biological objects, such as cells. The treatment to promote attaching of cells may be achieved by enhancing the cell affinity by coating the surface(s) with a positively charged polymer, such as poly-lysine, or exposing the surface(s) to a plasma treatment. The reference point decreasing or eliminating occurrence of biological objects may thus be achieved by excluding or erasing the treatment from one or more spots of the surface. The spots may be arranged in a pattern, such as a grid. This reference point facilitates the determination of a reference. Preferably, the occurrence of biological objects is eliminated and thereby the phase and amplitude of the light that is unaffected by the at least one biological object is known, which implies that a zero-level for light that is unaffected by biological objects is known. This may be utilized in the calculations of the analysis, which thereby are simplified. This also implies that the quality of the analysis is improved. The information about the zero-level for light that is unaffected by biological objects enables the determination of the height of the biological object, since without this information only relative measurements of the height are possible to obtain. One embodiment of the method according to the present invention comprises a step of determining of phase and/or amplitude of light that is unaffected by the at least one biological object, preferably by means of at least one reference point decreasing or eliminating occurrence of biological objects, which step is performed after step e. Preferably, the at least one reference point eliminates occurrence of biological objects.

In one embodiment of the present invention, the observation vessel or observation vessel lid comprises at least one calibrating reference. The size of this calibrating reference may be known per se and thus the setting of the scale of lengths is facilitated. Thereby it is possible to use the calibrating reference to determine the dimensions of the analyzed at least one biological object. This facilitates the study of development of biological objects, such as cell growth. The height of the calibrating reference may be known and thus it is possible to calibrate the phase shift. Normally, the refractive index of the medium is known, but the calibrating reference implies that it is possible to analyze a sample without knowing the refractive index of the medium, since the calculations of the analysis may be based on the known size of the calibrating reference. In one embodiment, the at least one calibrating reference is located on at least one of the first inner and outer surfaces and, if present, second inner and outer surfaces. In one embodiment, the at least one calibrating reference is at least one mark, such as a line, a scratch or a half-sphere. The calibrating reference may also be two or more marks separated by a known distance, such as a grid of half-spheres. The size of the mark, such as the length of the line, the scratch or the half-sphere, the height of the half-sphere and/or the distance between the half-spheres of the grid, is also known per se. The calibrating reference may be achieved during the manufacturing of the observation vessel or observation vessel lid, e.g. by using a mould with a recess or projection, by fixing an object to the observation vessel or observation vessel lid or by making a scratch in the observation vessel or observation vessel lid. One embodiment of the method comprises a step of calibrating the scale of length, preferably by means of at least one calibrating reference, which step is performed after step e.

Preferably, the pattern for positioning of the observation vessel or observation vessel lid and the calibrating reference are combined. For example parts of or all of the pattern for positioning may be used as a calibrating reference or vice versa.

By a transparent biological object is meant a biological object through which light may be transmitted, but the biological object may comprise absorBing parts, such as organelles. The biological object may for example be a cell, a pollen grain, a sperm, a slide culture, a tissue smear or a biopsy sample. In one embodiment of the present invention, the at least one trans-parent biological object is at least one cell. Preferably, the at least one trans-parent biological object is at least one living cell.

The sample to be analyzed comprises at least one transparent biological object and at least one medium. The at least one medium may be a fluid and is preferably a growth medium, such as a cell culture medium. The sample should be in contact with the first inner surface and, if present, the second inner surface, i.e. the medium and/or the biological object(s) should be in contact with the first inner surface and, if present, the second inner surface. Normally, the medium is in contact with these surfaces, while the biological object(s) may be anywhere between the two surfaces, i.e. hovering between the first and second inner surfaces or located on the first inner surface or on the second inner surface. Preferably, the at least one trans-parent biological object is located on the second inner surface.

According to one embodiment of the present invention, the observation vessel comprises a box, preferably in the form of a cuboid, in which the sample is kept. The first and second holding means may then be two opposite sides of the box. If the object beam is inciding from above, the first holding means is the top side of the box and the second holding means is the bottom side of the box. If the object beam is inciding from below, the first holding means is the bottom side of the box and the second holding means is the top side of the box. If the object beam is inciding from the side, the first holding means is one of the lateral sides and the second holding means is the opposite lateral side. It is obvious that the box may be provided with rounded corners, rounded edges, chamfers, recesses and/or other geometrical modifications. In one embodiment, the box has one or more openings e.g. for connecting the inner cavity of the box with one or more containers for storing a sample with a substantial volume and where only a portion of the sample is analyzed. The container facilitates the study of living biological object(s) over a substantial time, since the volume of the medium may be sufficiently large to provide the living biological object(s) with nutrients essential for the survival of the biological object(s). The openings may also enable flushing a sample or a medium through the observation vessel and then the sample comprising at least one transparent biological object or the medium is flowing between said first and second inner surfaces.

One embodiment of an observation vessel comprising a box in the form of a cuboid is shown in FIG. 3, where the first holding means 1, the second holding means 2 and the openings 6, 7 are visualized.

In another embodiment, the observation vessel comprises a cylinder, preferably with a flat bottom side and a flat top side, in which cylinder the sample is kept. If the object beam is inciding from above, the first holding means is the top side of the cylinder and the second holding means is the bottom side of the cylinder. If the object beam is inciding from below, the first holding means is the bottom side of the cylinder and the second holding means is the top side of the cylinder. It is obvious that the cylinder also may be provided with rounded edges, chamfers, recesses and/or other geometrical modifications. In one embodiment, the cylinder has one or more openings, e.g. for connecting the inner cavity of the cylinder with one or more containers for storing a sample with a substantial volume and where only a portion of the sample is analyzed. The container facilitates the study of living biological object(s) over a substantial time, since the volume of the medium may be sufficiently large to provide the living biological object(s) with nutrients essential for the survival of the biological object(s). The openings may also enable flushing a sample or a medium through the observation vessel and then the sample comprising at least one transparent biological object or the medium is flowing between said first and second inner surfaces.

In one embodiment of the present invention, one of said first and second holding means is detachable from the other. In one embodiment, the detachable holding means is immersed into said sample. When the first holding means is detachable from the second holding means, the first holding means may be a part of the observation vessel lid according to the present invention.

In one further embodiment of the present invention, the observation vessel comprises one bottom part with a bottom side and one or more lateral walls creating a bowl-like vessel, preferably with a flat bottom side. In this embodiment, the observation vessel also comprises a top part with a bottom side, preferably with a flat bottom side, which top part is detachable from the bottom part. The top part and/or the bottom part may also comprise means for arranging the top part in relation to the bottom part so as the bottom side of the top part is immersed into the sample to be analyzed, which sample is kept in the bottom part. If the object beam is inciding from above, the first holding means is the bottom side of the top part and the second holding means is the bottom side of the bottom part. If the object beam is inciding from below, the first holding means is the bottom side of the bottom part and the second holding means is the bottom side of the top part. Preferably, the bottom side of the bottom part is circular and thereby the bottom part only comprises one (circular) wall. In one embodiment, the bottom side of the top part is substantially smaller than the bottom side of the bottom part, which implies that the bottom side of the top part only is in contact with a portion of the surface of the sample. Thus, a portion of the surface of the sample is exposed to the ambient air making it possible to provide the studied at least one biological object, such as one or more cells, with gases essential for the survival of the studied biological object(s) without the use of a gas permeable holding means.

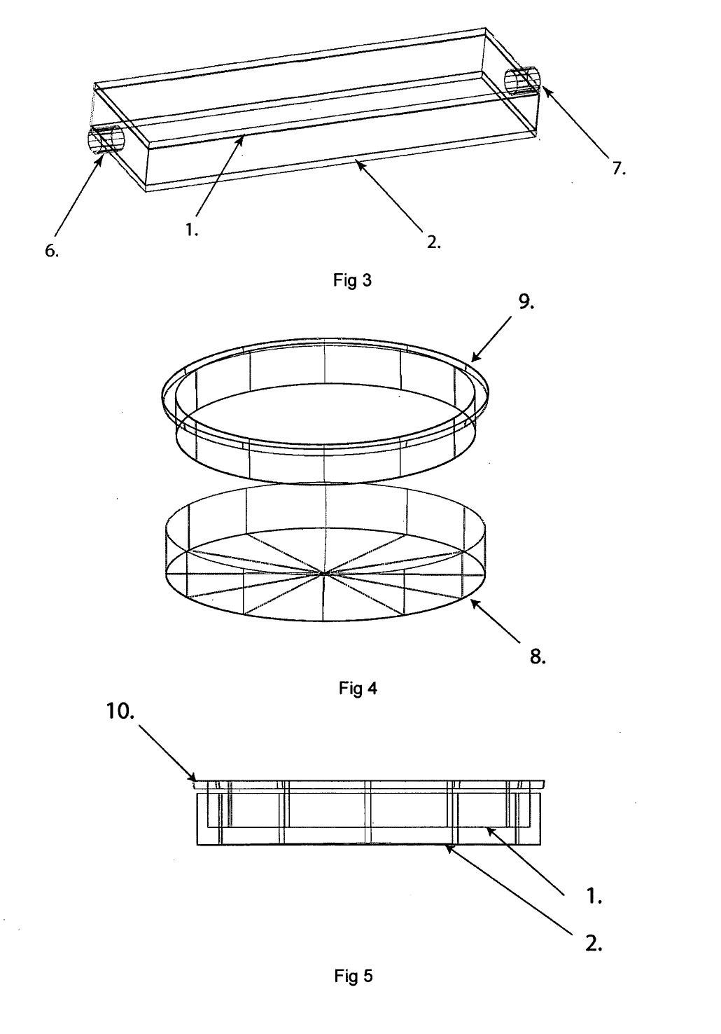

In FIGS. 4 and 5 one embodiment of an observation vessel comprising a top part 9 that is detachable from a bottom part 8 is shown. The top part 9 comprises the first holding means 1 and the bottom part 8 comprises the second holding means 2 and thus the first holding means 1 is detachable from the second holding means 2. The top part 9 comprises means 10 for arranging the top part 9 in relation to the bottom part 8 so as the first holding means 1 is immersed into the sample intended to be stored in the bottom part 8.

The observation vessel lid according to the present invention may be put on top of the bottom part of a standard cell culture vessel, which bottom part then comprises a part that represents and is considered as the second holding means. The part of the standard cell culture vessel that represents the second holding means should be transparent, at least for the wavelength of light passing through this part, i.e. the object beam of light. The standard cell culture vessel may for example be a Petri dish.

In one embodiment of the observation vessel lid according to the present invention, the observation vessel lid comprises means for arranging the observation vessel lid in relation to the bottom part of the standard cell culture vessel so as the first holding means of the observation vessel lid is immersed into the sample to be analyzed, which sample is kept in the bottom part of the standard cell culture vessel.

In one embodiment of the observation vessel lid according to the present invention, the first holding means of the observation vessel lid is substantially smaller than the inner bottom surface of the bottom part of the standard cell culture vessel, which implies that the first holding means of the observation vessel lid only is in contact with a portion of the surface of the sample. Thus, a portion of the surface of the sample is exposed to the ambient air making it possible to provide the studied at least one biological object, such as one or more cells, with gases essential for the survival of the studied biological object(s) without the use of a gas permeable holding means.

In one embodiment of the observation vessel lid according to the present invention, the first inner surface is parallel to the inner bottom surface of the bottom part of the standard cell culture vessel. By using parallel surfaces, the geometry of the unit comprising the observation vessel lid and the standard cell culture vessel is simple and known per se. The optical paths of the beams are therefore easier to predict. Thereby, the theoretical expressions and calculations are facilitated.

In one embodiment of the observation vessel lid according to the present invention, the observation vessel lid may be the top part 9 of the embodiment of the observation vessel shown in FIGS. 4 and 5.

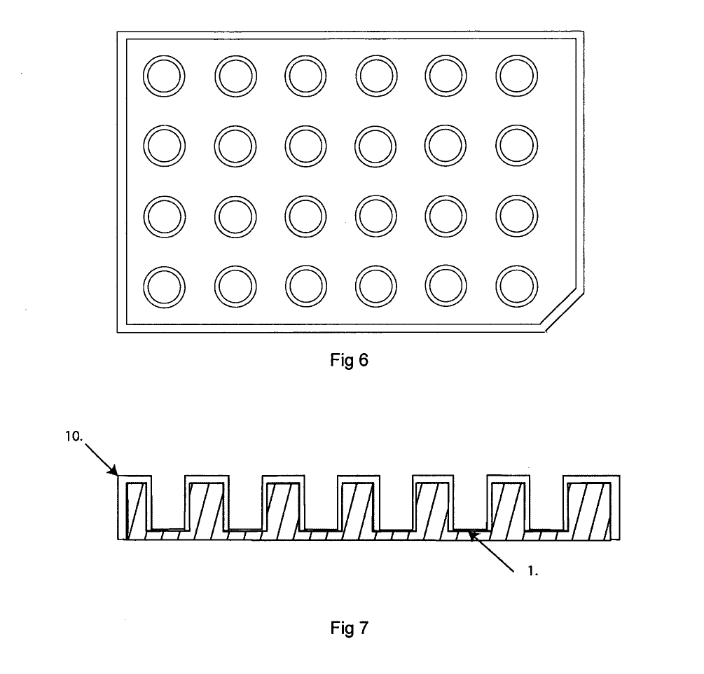

In one embodiment, the observation vessel lid comprises multiple first holding means, wherein each first holding means comprises a first outer surface and a first inner surface, wherein each of the first inner surfaces is provided to be immersed into a sample comprising at least one transparent biological object and at least one medium and to be in contact with the sample. This observation vessel lid may be put on top of a bottom part of a standard well cell culture plate, which bottom part then comprises parts that represent and are used as multiple second holding means. The standard well cell culture plate may for example be a 6 well cell culture plate, a 24 well cell culture plate or a 96 well cell culture plate. One embodiment comprising such multiple first holding means is shown in FIGS. 6 and 7. This observation vessel lid comprises the first holding means 1. This observation vessel lid also comprises means 10 for arranging the observation vessel lid in relation to a standard well cell culture plate so as each first holding means 1 is immersed into the sample intended to be stored in the mating well of the standard well cell culture plate.

The distance between the first inner surface and the second inner surface is preferably sufficiently large to accommodate the at least one transparent biological object intended to be analyzed. When cells are intended to be analyzed, the distance between the first inner surface and the second inner surface is advantageously at least as large as the dimension of one cell.

At least at the portion of the first and second holding means where the object beam passes through the first and second inner and outer surfaces in order to expose the sample to the object beam, the first and second holding means are transparent, at least for the wavelength of light passing through the first and second inner and outer surfaces, i.e. the object beam of light.

According to one embodiment of the present invention, the observation vessel comprises an enclosure between said first and second holding means, in which enclosure the sample is kept. The enclosure may have one or more openings, e.g. for connecting the enclosure with one or more containers for storing a sample with a substantial volume and where only a portion of the sample is analyzed. The container facilitates the study of living biological object(s) over a substantial time, since the volume of the medium may be sufficiently large to provide the living biological object(s) with nutrients essential for the survival of the biological object(s). The openings may also enable flushing a sample or a medium through the observation vessel and then the sample comprising at least one transparent biological object or the medium is flowing between said first and second inner surfaces.

By the expression “first and second inner and outer surfaces” is throughout this application meant first inner surface, first outer surface, second inner surface and second outer surface.

Analogously, by “first and second inner surfaces” is meant first inner surface and second inner surface, by “first and second outer surfaces” is meant first outer surface and second outer surface, by “first inner and outer surfaces” is meant first inner surface and first outer surface and by “second inner and outer surfaces” is meant second inner surface and second outer surface.

1. Observation vessel for digital holographic microscopy comprising a first holding means and a second holding means, wherein said first holding means comprises a first outer surface and a first inner surface and said second holding means comprises a second inner surface and a second outer surface, wherein said first and second inner surfaces are provided to keep a sample comprising at least one transparent biological object and at least one medium and to be in contact with said sample.

2. Observation vessel according to claim 1, wherein at least one of said first and second inner and outer surfaces is anti-reflection treated.

3. Observation vessel according to claim 1, wherein said first and second inner surfaces are parallel to each other.

4. Observation vessel according to claim 1, wherein at least one of said first and second holding means at least partly is permeable to gas.

5. Observation vessel according to claim 1, wherein one of said first and second holding means is detachable from the other.

6. Observation vessel according to claim 5, wherein the detachable holding means is immersible into said sample.

7. Observation vessel according to claim 1, wherein at least one of said first and second inner and outer surfaces comprises a pattern for positioning of said observation vessel in relation to a beam of light inciding against said first outer surface.

8. Observation vessel according to claim 1, wherein said observation vessel comprises at least one reference point decreasing or eliminating occurrence of biological objects.

9. Observation vessel according to claim 1, wherein said observation vessel comprises at least one calibrating reference.

10. Observation vessel according to claim 1, wherein said at least one transparent biological object is at least one cell.

11. Observation vessel lid for digital holographic microscopy comprising a first holding means, wherein said first holding means comprises a first outer surface and a first inner surface,
wherein said first inner surface is provided to be immersed into a sample comprising at least one transparent biological object and at least one medium and to be in contact with said sample.

12. Observation vessel lid according to claim 11, wherein at least one of said first inner and outer surfaces is anti-reflection treated.

13. Observation vessel lid according to claim 11, wherein said first holding means at least partly is permeable to gas.

14. Observation vessel lid according to claim 11, wherein at least one of said first inner and outer surfaces comprises a pattern for positioning of said observation vessel lid in relation to a beam of light inciding against said first outer surface.

15. Observation vessel lid according to claim 11, wherein said observation vessel lid comprises at least one reference point decreasing or eliminating occurrence of biological objects.

16. Observation vessel lid according to claim 11, wherein said observation vessel lid comprises at least one calibrating reference.

17. Observation vessel lid according to claim 11, wherein said at least one transparent biological object is at least one cell.

18. Observation vessel lid according to claim 11, wherein said lid comprises multiple first holding means, wherein each first holding means comprises a first outer surface and a first inner surface,
wherein each of said first inner surfaces is provided to be immersed into a sample comprising at least one transparent biological object and at least one medium and to be in contact with said sample.

19. Method for analyzing a sample comprising at least one transparent biological object and at least one medium by means of digital holographic microscopy, wherein said sample is kept in an observation vessel according to claim 1 or is located below an observation vessel lid according to claim 11, wherein said sample is in contact with said first inner surface and, if present, said second inner surface, comprising the steps of
a) creating at least one object beam and at least one reference beam of light, where said at least one object beam and said at least one reference beam are mutually coherent;
b) passing said at least one object beam through said first inner and outer surfaces and, if present, through said second inner and outer surfaces and thereby exposing said sample to said at least one object beam;
c) superimposing said at least one object beam that has passed through said sample with said at least one reference beam and thereby creating an interference pattern;
d) detecting said interference pattern, called hologram; and
e) reconstructing phase and/or amplitude information of object wavefront from said interference pattern.

20. The method according to claim 19, wherein reflections arising when said at least one object beam passes through one or more of said first inner and outer surfaces and, if present, said second inner and outer surfaces are reduced or eliminated.

21. The method according to claim 19, further comprising a step of positioning the observation vessel/observation vessel lid in relation to the at least one object beam, which step is performed before step b.

22. The method according to claim 19, further comprising a step of determining of phase and/or amplitude of light that is unaffected by the at least one biological object, which step is performed after step e.

23. The method according to claim 19, further comprising a step of calibrating the scale of length, which step is performed after step e.
